(19) United States
(12) Patent Application Publication
(10) Pub. No.: US 2026/0187539 A1
(43) Pub. Date: Jul. 2, 2026

(54) NON-TRANSITORY COMPUTER-READABLE RECORDING MEDIUM, MACHINE LEARNING DEVICE, AND MACHINE LEARNING METHOD

(71) Applicant: Fujitsu Limited, Kawasaki-shi (JP)

(72) Inventor: Hiroaki KINGETSU, Kawasaki (JP)

(73) Assignee: Fujitsu Limited, Kawasaki-shi (JP)

(21) Appl. No.: 19/546,488

(22) Filed: Feb. 23, 2026

Related U.S. Application Data
(63) Continuation of application No. PCT/JP2023/032000, filed on Aug. 31, 2023.

(51) Int. Cl. G06N 20/00

(52) U.S. Cl. CPC G06N 20/00

(57) ABSTRACT

A non-transitory computer-readable recording medium stores therein a program that causes a computer to execute a process including calculating, for a machine learning model having a plurality of mechanisms that each of the mechanisms generate attention information, cosine similarity of the attention information generated by each of the mechanisms, calculating an entropy of an aggregate of the attention information generated by the mechanisms, and training the machine learning model by minimizing the cosine similarity and maximizing the entropy.

### CROSS-REFERENCE TO RELATED APPLICATION

This application is a continuation of International Application No. PCT/JP2023/032000, filed on Aug. 31, 2023, and designating the U.S., the entire contents of which are incorporated herein by reference.

### FIELD

The embodiment discussed herein is related to a machine learning technique.

### BACKGROUND

There exist technologies for object recognition in images using machine learning. As an example, a Vision Transformer (ViT) is used for classification and object detection tasks by treating images as characters using an Encoder portion of Transformer used in a language model.
Non-Patent Literature 1: Emerging Properties in Self-Supervised Vision Transformers, ICCV2021, arxiv.org/abs/2104.14294.

### SUMMARY

According to an aspect of an embodiment, a non-transitory computer-readable recording medium stores therein a program that causes a computer to execute a process including calculating, for a machine learning model having a plurality of mechanisms that each generate attention information, cosine similarity of the attention information generated by each of the mechanisms, calculating an entropy of an aggregate of the attention information generated by the mechanisms, and training the machine learning model by minimizing the cosine similarity and maximizing the entropy.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example ViT;

FIG. 2 is a diagram illustrating an example Attention Map when the ViT is used;

FIG. 3 is a diagram illustrating an example of comparison of Attention between supervised learning and DINO as conventional techniques;

FIG. 4 is a diagram illustrating an example of comparison of Attention provided by Multi-head between supervised learning and DINO as conventional techniques;

FIG. 5 is a diagram illustrating an example of a problem with the conventional technique DINO;

FIG. 6 is a diagram illustrating an example of the configuration of a machine learning device 10 according to the present embodiment;

FIG. 7 is a flowchart illustrating an example of the flow of a training process according to the present embodiment;

FIG. 8 is a table illustrating an example of the accuracy by finetune for each method;

FIG. 9 is a diagram illustrating an example of the effect of each method;

FIG. 10 is a table illustrating an example of quantitative evaluation of each method; and

FIG. 11 is a diagram illustrating an example of the hardware configuration of the machine learning device 10 according to the present embodiment.

### DESCRIPTION OF EMBODIMENTS

However, Attention (attention/attention regions), which is information generated by each of multiple heads of Multi Head Attention (MHA) in a ViT architecture to indicate a region to pay attention to in an image, may overlap, resulting in wasted heads. Such problems may arise not only in the ViT architecture, but also in machine learning models that use a plurality of mechanisms to generate information indicating attention regions in an image.

Preferred embodiments will be explained with reference to accompanying drawings. The embodiments are not intended to limit the scope of the present invention. Each embodiment can be combined as appropriate to the extent that there is no inconsistency.

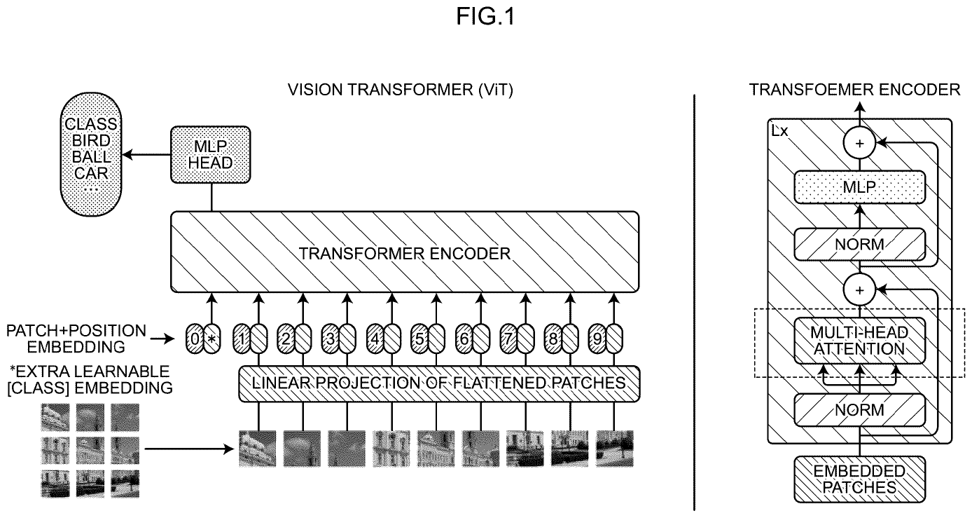

First, a machine learning model in the present embodiment will be explained. To perform tasks such as classification and object detection on images, the machine learning model in the present embodiment has a plurality of mechanisms, each of which generates information indicating an attention region in an image. As an example of such a machine learning model, a Vision Transformer (ViT), which is one of deep learning models, will be explained in the present embodiment. FIG. 1 is a diagram illustrating an example ViT. The Vit, for example, processes an image as sequence data (continuous data), such as sentences, which the ViT is good at. In the example in FIG. 1, the ViT treats one image as sequence data consisting of nine (3×3) image patches (patches). For example, the Vit performs processing including converting two-dimensional image data into one-dimensional sequence data for each patch and using the sequence data for each patch as input data to a Transformer Encoder to obtain the correspondence relation for each patch.

The Transformer Encoder also has a Multi Head Attention (MHA) unit, which is an architectural structure that uses multiple heads to indicate where in the image to focus on, as denoted by the dashed line in FIG. 1. Here, each of the multiple heads in the MHA is a mechanism that generates information indicating an attention region in the image. The MHA usually has 6 to 12 heads, and Attention (attention/attention region) that each head focuses on tends to overlap, resulting in wasted heads. Attention in the MHA and the Vision Transformer is information (attention information) indicating an attention region in image data.

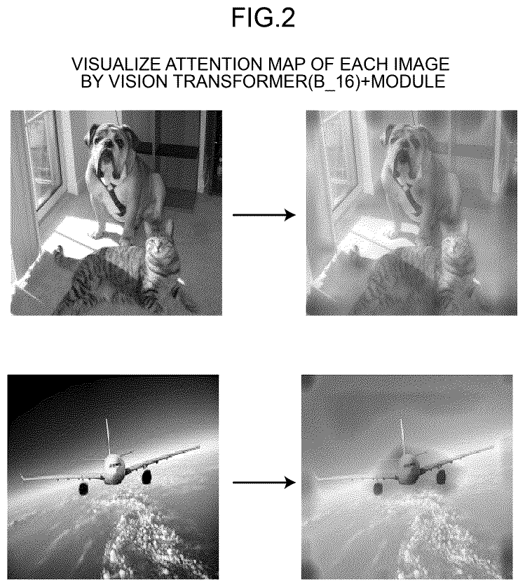

FIG. 2 is a diagram illustrating an example Attention Map when the ViT is used. FIG. 2 visualizes Attention Maps of images with a dog and a cat, and an airplane by the Vil using general supervised learning. In FIG. 2, the original images are on the right, and the Attention Maps are visualized on the left. As illustrated in FIG. 2, it is understood that Attention is concentrated, for example, even in an area that is normally not necessarily focused on, such as the edges of the images. This means, for example, that in a ViT using general supervised learning, the understanding by visualizing the Attention Map is not easy, and feature extraction is not necessarily decomposed for each head of the MHA on the Attention side in feature extraction.

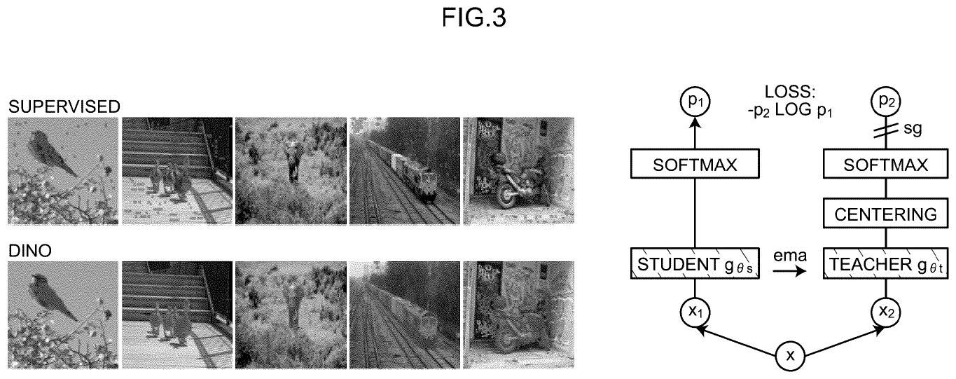

Attention according to a conventional technique will be described more specifically. FIG. 3 is a diagram illustrating an example of comparison of Attention between supervised learning and DINO as conventional techniques. DINO illustrated in FIG. 3 is, for example, a conventional technique described in “Emerging Properties in Self-Supervised Vision Transformers, ICCV2021”, which introduces self-supervised learning with distillation to Vil. In DINO, for example, different data extensions are input into Teacher and Student, and centering is performed to align the center of each feature to 0, as illustrated on the right side of FIG. 3. As illustrated on the left side of FIG. 3, for example, it is understood that DINO is less accurate than supervised learning (Supervised) but is able to pay Attention to objects.

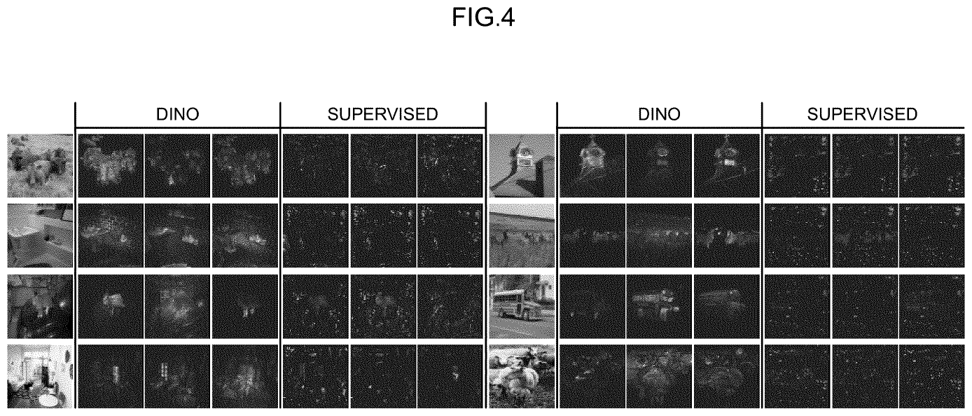

Next, an example of comparison of Attention between supervised learning (Supervised) and DINO for each head of the multi-head will be described. FIG. 4 is a diagram illustrating an example of comparison of Attention provided by Multi-head between supervised learning and DINO as conventional techniques. In the example in FIG. 4, Attention of the multi-head in the final layer, extracted from 8 different images, is illustrated, and three heads out of 12 heads of the ViT-base MHA are extracted. As illustrated in the example in FIG. 4, it is understood that, for example, DINO is able to extract more accurately Attention provided by each individual head of the multi-head than supervised learning (Supervised).

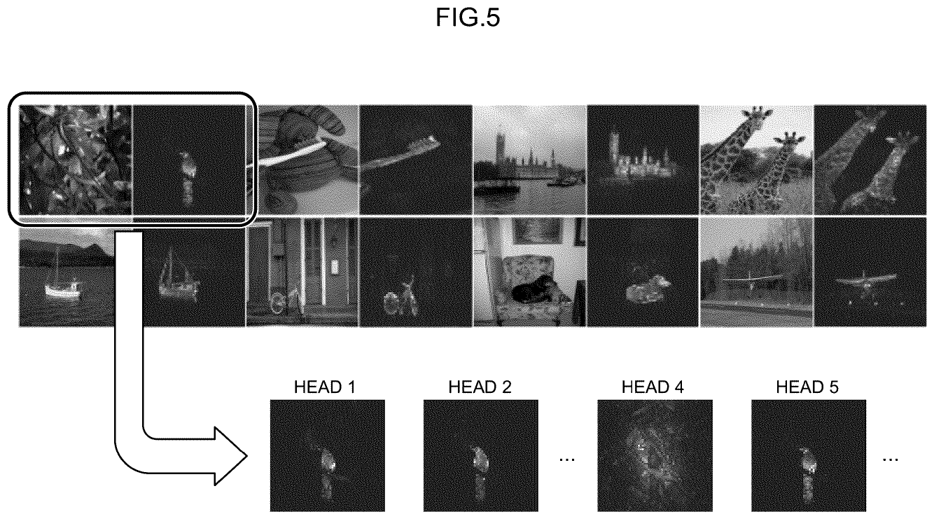

However, the conventional technique DINO also has the following problem. FIG. 5 is a diagram illustrating an example of the problem with the conventional technique DINO. FIG. 5 illustrates, at the bottom, an example of comparison of Attention for each head of the multi-head extracted by DINO from an image with a bird at the upper left corner. In the example in FIG. 5, Attention is extracted by four heads of the multi-head, Head1, Head2, Head4, and Head5. Referring to these, it is understood that Head4 extracts features including the surrounding environment, but there is not much difference among Head1, Head2, and Head5, indicating that feature extraction overlaps.

An object of the present embodiment is therefore to suppress the overlap of attention regions (Attention/attention) of multiple heads of the MHA. For example, the present embodiment explicitly separates Attention for each head, for example, a person into head, feet, torso, and the like, so that each head pays pinpoint-attention to different regions of the image.

In the present embodiment, for example, an entropy of Attention of each head of the MHA is minimized, or cosine similarity is minimized. For example, this processing can impose constraints so that each head of the MHA can focus on a specific portion or each head has a different weight, thereby suppressing the overlap in Attention of each head. Furthermore, in the present embodiment, for example, an entropy of the aggregate of Attention of all heads of the MHA is maximized. This processing makes it possible, for example, to train the ViT to use information from the entire image evenly and to weight Attention at a different position for each head of the MHA.

### Functional Configuration of Machine Learning Device 10

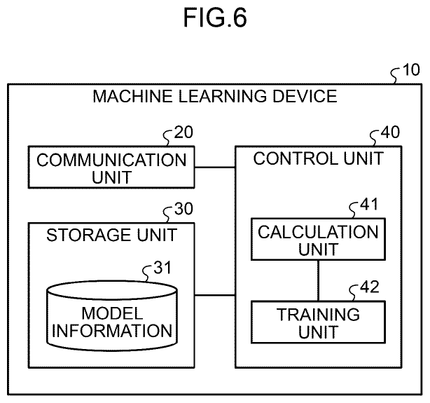

Referring to FIG. 6, the functional configuration of a machine learning device 10, which is the entity that executes the present embodiment, will be explained. FIG. 6 is a diagram illustrating an example of the configuration of the machine learning device 10 according to the present embodiment. The machine learning device 10 illustrated in FIG. 6 is an information processing device, such as a desktop personal computer (PC), a notebook PC, or a server computer. The machine learning device 10 is illustrated as a single computer in FIG. 6, but may be a distributed computing system including a plurality of computers. The machine learning device 10 may be a cloud computing device managed by a service provider offering cloud computing services.

As illustrated in FIG. 6, the machine learning device 10 includes a communication unit 20, a storage unit 30, and a control unit 40.

The communication unit 20 is a processing unit that controls communication with other devices, for example, a communication interface such as a network interface card or a USB (Universal Serial Bus) interface.

The storage unit 30 has the function of storing various data and a computer program to be executed by the control unit 40, and stores therein, for example, model information 31.

The model information 31 includes, for example, information on ViTs widely used in image classification and object detection models, as well as model parameters and training data for building the ViTs.

The above information stored in the storage unit 30 is only an example, and the storage unit 30 can store therein various other information in addition to the above information.

The control unit 40 is a processing unit that controls the entire machine learning device 10, for example, a processor. The control unit 40 includes a calculation unit 41 and a training unit 42. Each processing unit is an example of electronic circuitry that the processor has or an example of a process that the processor executes.

For example, for a machine learning model having a plurality of mechanisms, each of which generates attention information, the calculation unit 41 calculates cosine similarity of the attention information generated by each of the mechanisms. The calculation unit 41 also calculates, for example, the cosine similarity of attention (Attention/attention region) of each head of the MHA in the Transformer, which is a deep learning model. The calculation unit 41 also calculates, for example, an entropy of the aggregate of attention information generated by the mechanisms of the machine learning model. The calculation unit 41 also calculates, for example, the entropy of the aggregate of attention of all heads of the MHA. The calculation unit 41 also calculates, for example, a second entropy of the attention information generated by the mechanisms of the machine learning model. The calculation unit 41 also calculates, for example, the second entropy of attention of each head of the MHA.

The training unit 42, for example, trains the machine learning model such as Transformer to minimize the cosine similarity of attention of each head of the MHA that is calculated by the calculation unit 41 and maximize the entropy of the aggregate of attention of all heads of the MHA that is calculated by the calculation unit 41. In addition, the training unit 42, for example, trains the machine learning model such as Transformer to minimize the second entropy of attention of each head of the MHA.

The process of minimizing the cosine similarity of the attention information generated by each of the mechanisms of the machine learning model includes, for example, a process of minimizing a loss, wherein the loss is the average of the cosine similarity of weights of the attention information generated by the mechanisms. The process of minimizing the cosine similarity of attention of each head of the MHA includes, for example, a process of minimizing a loss, wherein the loss is the average of the cosine similarity of the weight of attention of each head of the MHA.

The minimization of the cosine similarity will be explained in more detail. For example, suppose that the cosine similarity between two weight matrices Aᵢ and Aⱼ is defined as in the following equation (1).

$$cosine\_similarity ( {A}_{i} , {A}_{j} ) = \frac{{A}_{i} \cdot {A}_{j}}{‖ {A}_{i} ‖ ‖ {A}_{j} ‖} \qquad ( 1 )$$

When equation (1) is defined in this way, for example, a loss Lₛᵢₘ is the average of the cosine similarity of each attention for N heads of the multi-head (in the final block) of the Transformer and can be expressed by the following equation (2).

$${L}_{sim} = \frac{1}{N ( N - 1 )} {\sum }_{i = 1}^{N} {\sum }_{{j \neq 1}^{j = 1}}^{N} cosine\_similarity ( {A}_{i} , {A}_{j} ) \qquad ( 2 )$$

The training unit 42 then trains the Transformer to minimize the loss Lₛᵢₘ using, for example, equation (2).

The process of minimizing the second entropy of the attention information generated by the mechanisms of the machine learning model includes, for example, a process of minimizing a loss, wherein the loss is the sum of Shannon entropy for the weights of the attention information generated by the mechanisms. The process of minimizing the second entropy of the attention of each head of the MHA includes, for example, a process of minimizing a loss, wherein the loss is the sum of Shannon entropy for the weight of the attention of each head of the MHA.

The minimization of the second entropy will be explained in more detail. The training unit 42, for example, trains the Transformer to minimize a loss L of the sum of Shannon entropy H as expressed by the following equation (3) for the attention weights Aᵢ (i\in {1, 2, . . . 3, N}) of N heads of the multi-head of the Transformer.

$$L = {\sum }_{i = 1}^{N} H ( {A}_{i} ) \qquad ( 3 )$$

In equation (3), H(Aᵢ) is expressed, for example, by the following equation (4).

$$H ( {A}_{i} ) = - {\sum }_{j , k} {A}_{i , j , k} {log}_{2} ( {A}_{i , j , k} ) \qquad ( 4 )$$

However, in equation (4), A_{i,j,k} is, for example, an output matrix element j, k of head i, and the base of log is 2 or e.

The process of maximizing the entropy of the aggregate of the attention information generated by the mechanisms of the machine learning model includes, for example, a process of maximizing a loss, wherein the loss is the sum of Shannon entropy for the weights of the attention information generated by the mechanisms. The process of maximizing the entropy of the aggregate of attention of all heads of the MHA includes, for example, a process of maximizing a loss, wherein the loss is the sum of Shannon entropy for the weights of attention of all heads.

The maximization of the entropy will be explained in more detail. For example, the Shannon entropy is expressed by the following equation (5) when the input sequence length of the Transformer is L for the weight matrix Aᵢ (i\hat{ }in {1, 2, . . . , N}), and each sequence is l. The sequence here means, for example, a patch when each image is divided into rectangles.

$${H}_{se} = {\sum }_{l} - {B}^{( l )} log {B}^{( l )} \qquad ( 5 )$$

The training unit 42, for example, trains the Transformer to maximize a loss Hₛₑ expressed by equation (5). In equation (5), B is expressed, for example, by the following equation (6).

$$B = softmax ( {\sum }_{i} {A}_{i} ) . \qquad ( 6 )$$

### Process Flow

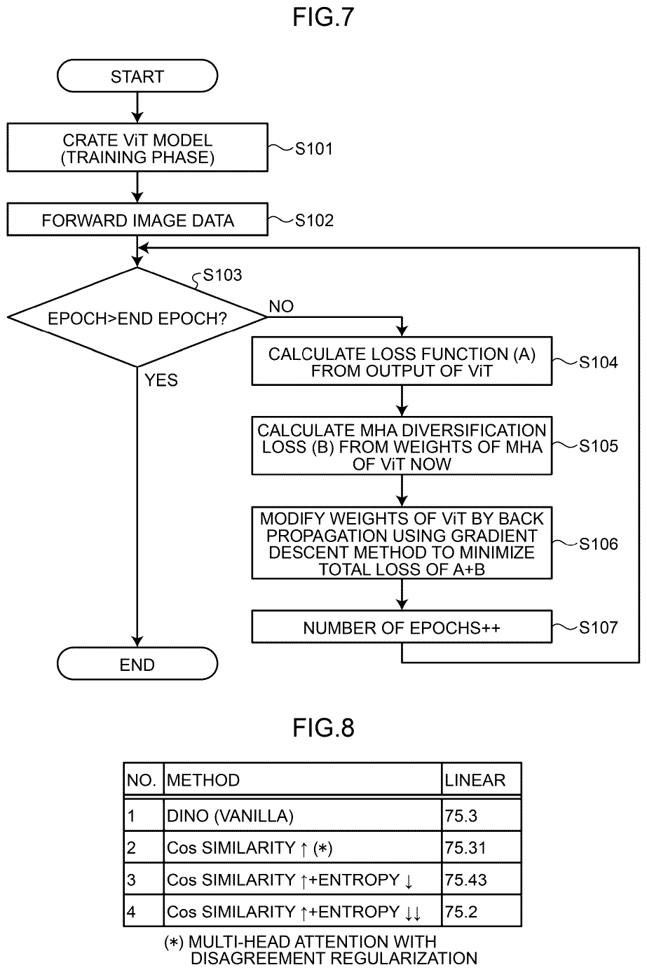

Next, referring to FIG. 7, an example flow of a training process by the machine learning device 10 will be explained. FIG. 7 is a flowchart illustrating an example of the flow of the training process according to the present embodiment.

First, the machine learning device 10, for example, creates a Vit model (step S101).

Next, the machine learning device 10, for example, forwards image data to the Vit model created at step S101 (step S102).

Next, when the number of epochs reaches a predetermined number of times set in advance (Yes at step S103), the training process illustrated in FIG. 7 ends.

On the other hand, if the epochs do not reach the predetermined number of times set in advance (No at step S103), the machine learning device 10 calculates a loss function (A) from the output of the ViT to which the image data is forwarded at step S102 (step S104). Here, the loss function (A) is, for example, a cross-entropy loss with a correct label in a case of supervised learning, or a KL loss or a cross-entropy loss between teacher and student models in a case of self-supervised learning, which is pretraining using distillation.

Next, the machine learning device 10, for example, calculates an MHA diversification loss (B) from the weights of the MHA of the ViT now (step S105). Here, the MHA diversification loss (B) is, for example, the loss expressed by equation (2) or equation (3) above.

Next, the machine learning device 10, for example, modifies the weights of ViT by back propagation using a gradient descent method to minimize the total loss of loss function (A)+MHA diversification loss (B) (step S106). For example, in this case, the weights of ViT may be further modified to maximize the loss represented by equation (5) above.

Next, the machine learning device 10, for example, adds an epoch (step S107) and repeats the process until the epochs reach the predetermined number of times set in advance (steps S103 to S107).

### Effects

Next, the effects of the training process according to the present embodiment will be explained for reference. In the training method that minimizes the cosine similarity of Attention of each head of the MHA and the training method that minimizes the entropy of Attention of each head of the MHA according to the present embodiment, the former exhibited superior effects on accuracy and the like. In the following, therefore, the effect of the training method that minimizes the entropy of Attention of each head of the MHA according to the present embodiment is omitted, and the effect of the training method that minimizes the entropy of Attention of each head of the MHA will be described.

FIG. 8 is a table illustrating an example of the accuracy by finetune for each method. In FIG. 8, DINO (vanilla) is a training method by DINO, which is, for example, a conventional technique described in “Emerging Properties in Self-Supervised Vision Transformers, ICCV2021”. In FIG. 8, Cos similarityt is, for example, a training method that minimizes the cosine similarity of Attention of each head of the MHA. Cos Similarityt↑Entropy← and Cos Similarity↑+Entropy←← are training methods that minimize the cosine similarity of Attention of each head of the MHA and maximize the entropy of the aggregate of Attention of all heads according to the present embodiment. The arrow ↑ or ← indicates the strength of regularization (hyperparameter). In FIG. 8, for example, Linear is obtained with 100 epochs, a single fully-connected layer, finetune on train, and then evaluation on validation, and KNN is obtained with training on train and then evaluation on validation. Referring to FIG. 8, it is understood that the accuracy by each method is generally the same, and in particular, Cos Similarityt↑Entropy← has the best accuracy.

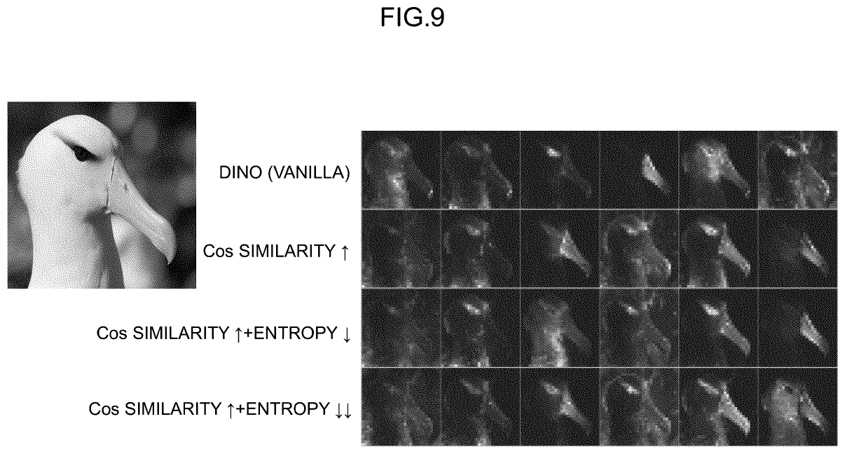

FIG. 9 is a diagram illustrating an example of the effect of each method. FIG. 9 is a diagram illustrating an example of comparison of Attention provided by the Multi-head (for 6 heads) in each method in Vit-S, patch size 16, head 6, 300 epochs. Referring to FIG. 9, it is understood that compared with the conventional technique DINO (vanilla), the three methods according to the present embodiment are able to suppress the overlap of Attention by each head (e.g., attention is not paid only to the bird's beak) although visually slightly.

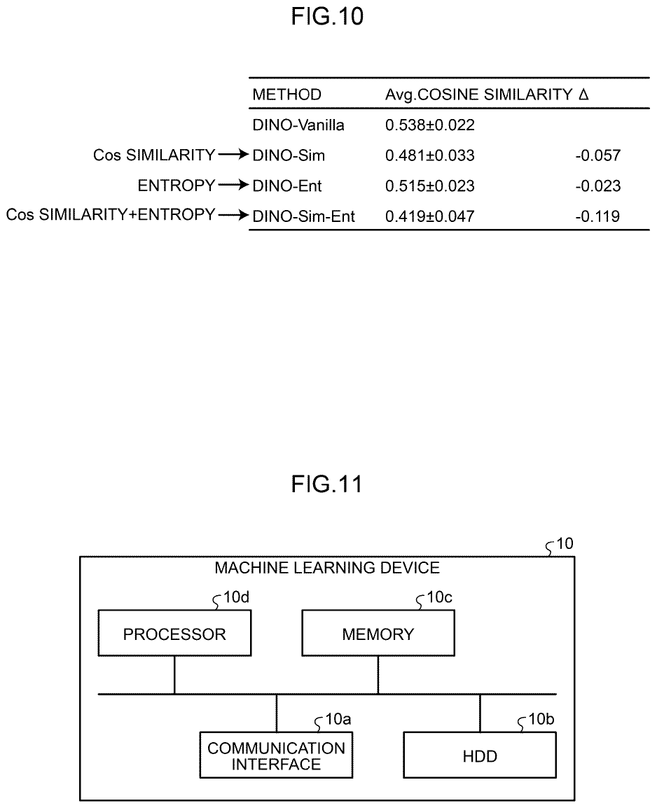

FIG. 10 is a table illustrating an example of quantitative evaluation of each method. FIG. 10 illustrates, as a quantitative evaluation of each method, the similarity (cos similarity) between each head of the MHA when using each method.

In FIG. 10, DINO-Vanilla is, for example, a training method by the conventional technique DINO which is described in “Emerging Properties in Self-Supervised Vision Transformers, ICCV2021”. In FIG. 10, DINO-Sim is, for example, a training method that minimizes the cosine similarity of Attention of each head of the MHA according to the present embodiment. In FIG. 10, DINO-Ent is, for example, a training method that maximizes the entropy of the aggregate of Attention of all heads of the MHA according to the present embodiment. In FIG. 10, DINO-Sim-Ent is, for example, a training method that minimizes the cosine similarity of Attention of each head of the MHA and maximizes the entropy of the aggregate of Attention of all heads according to the present embodiment.

Referring to FIG. 10, it is understood that the weights of the final model are trained with smaller cos similarity between heads when trained to minimize the cosine similarity of Attention of each head of the MHA. In particular, the DINO-Sim-Ent has the smallest cos similarity, indicating that training is performed with more diversity.

As described above, the machine learning device 10 calculates, for a machine learning model having a plurality of mechanisms, each of which generates attention information, cosine similarity of the attention information generated by each of the mechanisms, calculates an entropy of the aggregate of the attention information generated by the mechanisms, and trains the machine learning model to minimize the cosine similarity and maximize the entropy.

In this way, the machine learning device 10 trains the machine learning model to minimize the cosine similarity of the attention information generated by each of the mechanisms and to maximize the entropy of the aggregate of the attention information generated by the mechanisms. With this configuration, the machine learning device 10 can suppress the overlap of attention regions among multiple heads of the MHA.

A computer is caused to execute a process to be executed by the machine learning device 10 to calculate a second entropy of the attention information generated by the mechanisms. The process of training the machine learning model includes a process of training the machine learning model to minimize the cosine similarity and the second entropy and maximize the entropy.

With this configuration, the machine learning device 10 can suppress the overlap of attention regions among multiple heads of the MHA more.

The process to be executed by the machine learning device 10 to minimize the cosine similarity includes a process of minimizing a loss, wherein the loss is the average of the cosine similarity of weights of the attention information generated by the mechanisms.

With this configuration, the machine learning device 10 can suppress the overlap of attention regions among multiple heads of the MHA.

The process to be executed by the machine learning device 10 to minimize the second entropy includes a process of minimizing a loss, wherein the loss is the sum of Shannon entropy for weights of the attention information generated by the mechanisms.

With this configuration, the machine learning device 10 can suppress the overlap of attention regions among multiple heads of the MHA.

The process to be executed by the machine learning device 10 to maximize the entropy includes a process of maximizing a loss, wherein the loss is the sum of Shannon entropy for weights of the attention information generated by the mechanisms.

With this configuration, the machine learning device 10 can suppress the overlap of attention regions among multiple heads of the MHA.

### System

Processing procedures, control procedures, specific names, and information including various data and parameters described in the above document and drawings may be changed as desired unless otherwise specified. The specific examples, distributions, numerical values, and the like described in the embodiment are only examples and may be changed as desired.

The specific forms of distribution and integration of the components of the machine learning device 10 are not limited to those illustrated in the drawings. For example, the training unit 42 of the machine learning device 10 may be distributed across a plurality of processing units, or the calculation unit 41 and the training unit 42 of the machine learning device 10 may be integrated into a single processing unit. In other words, all or some of the components may be functionally or physically distributed and integrated into any units, depending on various loads and use conditions. Furthermore, each processing function of each device can be implemented in whole or in part by a central processing unit (CPU) and a computer program that is analyzed and executed by the CPU, or by hardware using wired logic.

FIG. 11 is a diagram illustrating an example of the hardware configuration of the machine learning device 10 according to the present embodiment. As illustrated in FIG. 11, the machine learning device 10 includes a communication interface 10a, a hard disk drive (HDD) 10b, a memory 10c, and a processor 10d. The units illustrated in FIG. 11 are interconnected by buses or the like.

The communication interface 10a is a network interface card or the like that communicates with other information processing devices. The HDD 10b, for example, stores therein a computer program and data to operate each of the functions illustrated in FIG. 6 and the like.

The processor 10d is a CPU, a micro processing unit (MPU), a graphics processing unit (GPU), or the like. The processor 10d may be implemented by an integrated circuit such as an application specific integrated circuit (ASIC) or a field programmable gate array (FPGA). The processor 10d, for example, reads from the HDD 10b or the like a computer program that executes the same processing as each of the processing units illustrated in FIG. 6 and the like, and loads the read computer program into the memory 10c. Thus, the processor 10d can operate as a hardware circuit that executes the processing that implements each of the functions illustrated in FIG. 6 and the like.

The machine learning device 10 may read the computer program from a recording medium by a medium reader and execute the read computer program to implement the same functions as in the foregoing embodiment. The computer program referred to in other embodiments is not limited to being executed by the machine learning device 10. For example, the foregoing embodiment may be similarly applied to a case where an information processing device other than the machine learning device 10 executes a computer program, or a case where the machine learning device 10 and another information processing device cooperate to execute a computer program.

The computer program may be distributed over a network such as the Internet. The computer program may be recorded on a computer-readable storage medium such as a hard disk, a flexible disk (FD), a CD-ROM, a magneto-optical disk (MO), a digital versatile disc (DVD), or the like. The computer program may then be executed by being read from the recording medium by the machine learning device 10 or the like.

In one aspect, the overlap of attention regions among multiple heads of the MHA can be suppressed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
calculating, for a machine learning model having a plurality of mechanisms that each generate attention information, cosine similarity of the attention information generated by each of the mechanisms;
calculating an entropy of an aggregate of the attention information generated by the mechanisms; and
training the machine learning model by minimizing the cosine similarity and maximizing the entropy.

2. The non-transitory computer-readable recording medium according to claim 1, wherein
the process further includes calculating a second entropy of the attention information generated by the mechanisms, wherein
the training includes training the machine learning model to minimize the cosine similarity and the second entropy and maximize the entropy.

3. The non-transitory computer-readable recording medium according to claim 1, wherein the minimizing the cosine similarity includes minimizing a loss, wherein the loss is an average of the cosine similarity of weights of the attention information generated by the mechanisms.

4. The non-transitory computer-readable recording medium according to claim 2, wherein the minimizing the second entropy includes minimizing a loss, wherein the loss is a sum of Shannon entropy for weights of the attention information generated by the mechanisms.

5. The non-transitory computer-readable recording medium according to claim 1, wherein the maximizing the entropy includes maximizing a loss, wherein the loss is a sum of Shannon entropy for weights of the attention information generated by the mechanisms.

6. A machine learning device comprising:
a processor configured to:
calculate, for a machine learning model having a plurality of mechanisms that each generate attention information, cosine similarity of the attention information generated by each of the mechanisms;
calculate an entropy of an aggregate of the attention information generated by the mechanisms; and
train the machine learning model by minimizing the cosine similarity and maximizing the entropy.

7. A machine learning method comprising:
calculating, for a machine learning model having a plurality of mechanisms that each generate attention information, cosine similarity of the attention information generated by each of the mechanisms;
calculating an entropy of an aggregate of the attention information generated by the mechanisms; and
training the machine learning model by minimizing the cosine similarity and maximizing the entropy, using a processor.
